(19) United States
(12) Patent Application Publication
(10) Pub. No.: US 2010/0148027 A1
(43) Pub. Date: Jun. 17, 2010

(54) SENSOR BRACKET FOR AT LEAST ONE SENSOR ON A GAS TURBINE

(75) Inventor: Olaf LENK, Berlin (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/636,415

(22) Filed: Dec. 11, 2009

(30) Foreign Application Priority Data
Dec. 12, 2008 (DE) 10 2008 061 648.6

(51) Int. Cl. G01D 11/30

(52) U.S. Cl. 248/309.1

(57) ABSTRACT

A sensor bracket (1) for at least one sensor (5) on a gas turbine, made of at least one fiber-composite material (10), with the fibers (7) embedded in the fiber-composite material (10) being oriented at an angle α relative to an axis x extending vertically to a free end edge (3) of the sensor bracket (1) in a plane established by the fibers (7), and the stiffness and the natural frequencies of the sensor bracket (1) being defined by said angle α, with the natural frequencies of the sensor bracket (1) lying outside of the frequency range of the sensor bracket (1), which includes the measuring range of the sensor (5).

This application claims priority to German Patent Application DE102008061648.6 filed Dec. 12, 2008, the entirety of which is incorporated by reference herein.

This invention relates to a sensor bracket for at least one sensor on a gas turbine.

Gas turbines, which, for example, are used as jet engines, employ complex measuring chains for surveying individual operating parameters and performing control in dependence of these operating parameters (e.g. temperature, pressure, vibration). Parameter measurement is performed with sensors mounted on the gas turbine or the jet engine, respectively. The operating parameters obtained by parameter measurement are subjected to signal processing. As a result of this signal processing, the gas turbine or the jet engine, respectively, is actively controllable, generating closed-loop control.

The sensors used for parameter measurement must be mounted on a structure, with metallic brackets being generally used. These metallic brackets are currently made from welded plates or by milling from a solid material.

The main functionality of the brackets is to maintain a stable position of the sensors without influencing the measuring characteristics of the latter. Such influence can occur if the running gas turbine or jet engine, respectively, excites the natural vibration behavior of the brackets in such a manner that operation of the sensors is disturbed. This disturbance is due to locally high vibration deformation occurring with excitation of a natural frequency of the bracket.

Metallic brackets have only limited options for influencing their dynamic behavior. These include both selection of materials and design. In particular, in the area of low-temperature application, a change from aluminum to titanium or steel incurs a significant increase in weight. Design is often limited by the installation space available.

The density of the material used and the geometry of the brackets give rise to natural frequencies in the brackets which disturb the measuring signals of the sensors. By partly extensive modifications of the brackets, it can be attempted to shift the natural frequencies out of the resonant range.

The natural vibration behavior is dependent on the three parameters—mass, stiffness and damping of the brackets. With mass and stiffness having countervailing effects, variability in setting the natural vibration behavior of the brackets is severely compromised.

Specification EP 0 768 472 A2 describes a shaft for a motor vehicle on which the natural frequency is set by selection of the modulus of elasticity of carbon fibers in a carbon fiber-composite material. The natural frequency of the shaft must be higher than the speed.

Specification JP 09317821 A discloses that the natural frequency of a fiber-reinforced composite material is set by use of a memory alloy embedded into the composite material. It is also described that the adjustment of the natural frequency is accomplished by setting the modulus of elasticity of the composite material.

Both publications are here limited to the setting of the modulus of elasticity by the selection of material.

A broad aspect of the present invention is to provide a sensor bracket with which a stable position of the sensors is guaranteed in operation.

In accordance with the present invention, provision is made for a sensor bracket for at least one sensor on a gas turbine made of at least one fiber-composite material, with the fibers embedded in the fiber-composite material being oriented at an angle α relative to an axis x extending vertically to a free end edge of the sensor bracket in a plane established by the fibers. The stiffness and the natural frequencies of the sensor bracket are defined by said angle α, with the natural frequencies of the sensor bracket lying outside of the frequency range of the sensor bracket, which includes the measuring range of the sensor.

The fiber-composite material enables the stiffness of the sensor bracket to be set with low material density. Adaptation of the orientation of the fibers at a certain angle, owing to the resultant anisotropy of the material structure, leads to a direct change in the stiffness and, thus, the dynamic behavior (natural frequencies) of the sensor bracket.

Moreover, the fiber-composite material has excellent damping behavior, reducing vibration of the sensor bracket and therefore contributing to a long service life. In addition, the fiber-composite material provides for a saving in weight and additional degrees of freedom in the design of the sensor bracket, as compared to metallic brackets.

Specific definition of the natural frequencies of the sensor bracket enables the sensor to be stably positioned in operation, thereby minimizing disturbances during measurement or measuring inaccuracies, respectively. In particular, the stiffness is adaptable for taking account of individual vibration modes of the sensor bracket.

In a preferred embodiment, the fibers are arranged parallel to each other in only one direction. This fiber arrangement is easily and cost-effectively producible.

In an alternative embodiment, the fibers are arranged angularly to each other. This arrangement of the fibers increases the stiffness of the sensor bracket.

In addition, the stiffness and the natural frequencies of the sensor bracket can also be defined by the type of the fibers, the texture of the fibers, the type of the matrix, the fiber volume content, the form of delivery of the fibers and/or the type of manufacture of the fiber-composite material.

Fiber-composite materials allow the stiffness to be further influenced by the parameters specified. The parameters also include, for example, the fiber material (e.g. glass fiber, carbon fiber) and the fiber length (e.g. continuous fiber, short fiber).

Preferably, the sensor bracket is essentially z-shaped, l-shaped or u-shaped, with the fibers following the shape of the sensor bracket. This simple design presents good stability and low space requirement.

In a further advantageous embodiment of the present invention, the sensor bracket has at least one side member which is also made of a fiber-composite material and whose fibers are arranged at an angle β relative to an axis z extending vertically to an end edge of the side member in a plane established by the fibers, with the stiffness and the natural frequencies of the sensor bracket being additionally defined by said angle β.

The side member increases the stability of the z-shaped, l-shaped or u-shaped sensor bracket and enables the natural frequencies of the sensor bracket to be further influenced.

In particular, the sensor bracket can have a metallic base to which the fiber-composite material is applied. Also the side member can have a metallic base to which the fiber-composite material is applied. The metallic base(s) enable(s) the stability and the stiffness of the sensor bracket to be further influenced.

The state of the art and two embodiments of the present invention are more fully described below in light of five figures, where:

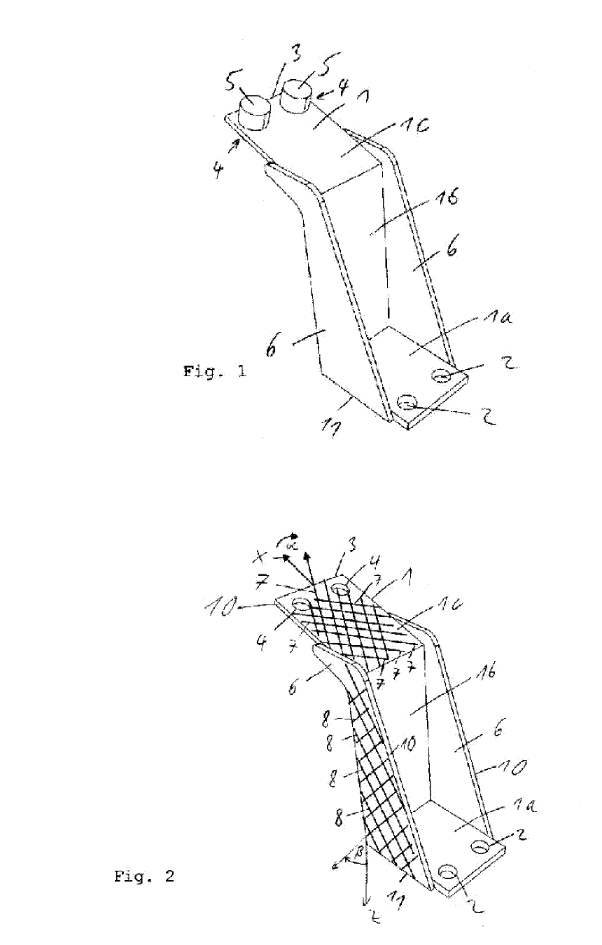

FIG. 1 is a perspective view of a sensor bracket in accordance with the state of the art,

FIG. 2 is a perspective view of a sensor bracket in accordance with the present invention,

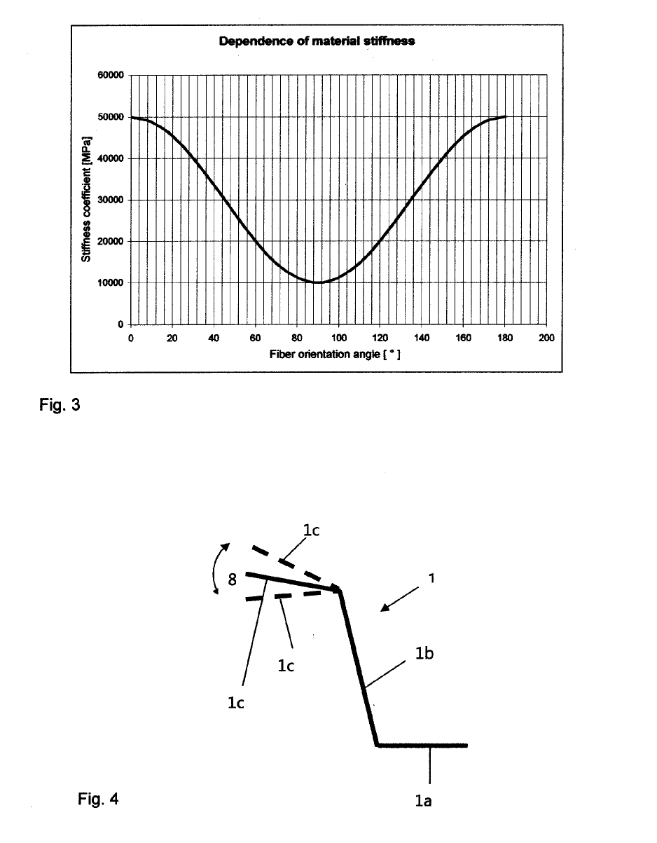

FIG. 3 is a diagram showing the stiffness coefficient in dependence of the fiber angle,

FIG. 4 is a schematic side view of the sensor bracket in accordance with the present invention,

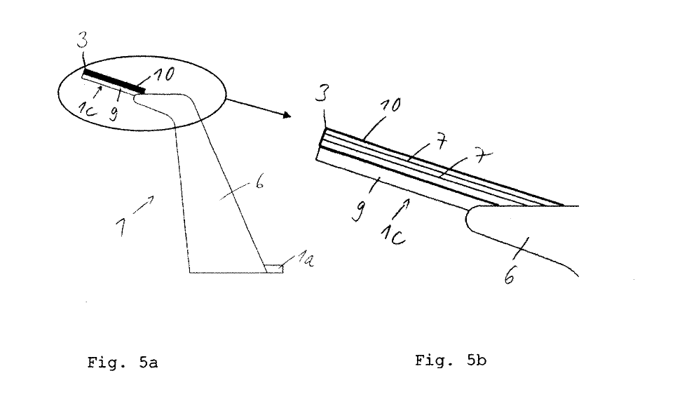

FIG. 5a is an alternative embodiment of the sensor bracket in accordance with the present invention, and

FIG. 5b is a detail view of the alternative embodiment as per FIG. 5a.

FIG. 1 shows a sensor bracket 1 in accordance with the state of the art. The sensor bracket 1 includes two mounting holes 2, a free end edge 3, two sensor holes 4, two sensors 5 and two side members 6.

The one-piece sensor bracket 1 is essentially z-shaped, with the z-shape being formed by a mounting part 1a angled from the center part 1b and a sensor part 1c again angled from the center part 1b. The mounting part 1a and the sensor part 1c are angled in opposite directions relative to the center part 1b. However, an l-shape or a u-shape or an otherwise angled shape of the sensor bracket 1 is also possible.

The free end edge 3 limits the sensor part 1c of the sensor bracket 1. Arranged in parallel with the free end edge 3 are two sensor holes 4 which, in FIG. 1, are concealed by the two sensors 5 mounted in the sensor holes 4.

Two mounting holes 2 are disposed at the end of the mounting part 1a. Two essentially l-shaped, parallel side members 6 are provided on the z-shaped sensor bracket 1. The end edge 11 limits the side members 6 in direction of the mounting parts 1a.

The sensor bracket 1 is made of a metallic material.

In operation, the sensor bracket 1 as per FIG. 1 is attached via the mounting holes 2 to the gas-turbine structure of the gas turbine, with structure and gas-turbine not being shown. The sensors 5 measure, for example, pressure, temperature and vibrations on the gas turbine. In the course of this, the gas-turbine vibrations excite the sensor bracket 1 to vibrate. When a natural frequency of the sensor bracket 1 is reached, the measuring operation of the sensors 5 will be disturbed.

FIG. 2 shows a sensor bracket 1 according to the present invention. This sensor bracket 1 is only geometrically identical to the sensor bracket 1 in FIG. 1. The sensor holes 4 hidden by the sensors 5 in FIG. 1 are visible in FIG. 2.

The inner structure of the sensor bracket 1 as per FIG. 2 differs fundamentally from the sensor bracket 1 shown in FIG. 1.

The sensor bracket 1 in FIG. 2 is made of a fiber-composite material 10. The fibers 7 are arranged rectangularly to each other. Relative to a local axis x, which extends vertically to the end edge 3 of the sensor bracket 1 in a plane established by the fibers 7, the fibers 7 extend at an angle α or α+90°, respectively. At the transitions from the sensor part 1c to the center part 1b and from the center part 1b to the mounting part 1a, the entire network formed by the fibers 7 is bent.

The two side members 6 are also made of a fiber-composite material 10. Like the fibers 7 of sensor bracket 1, the fibers 8 of the side members are arranged rectangularly to each other. Relative to a local axis z, which extends vertically to the end edge 11 of the side member 6 in a plane established by the fibers 8, the fibers 8 extend at an angle β or β+90°, respectively.

Alternatively, the sensor bracket 1 can also be provided without the side members 6. Instead of the two sensors 5 (cf. FIG. 1), other numbers of sensors can be positioned on the sensor bracket, including only one or, for example, three sensors 5.

The sensor bracket 1 has an infinite number of natural frequencies at which natural vibration behavior occurs. Here, the lowest natural frequencies have the highest vibration deformation amplitudes. These deformations, on their part, can influence or invalidate the measurements of the sensors 5.

The natural frequencies are generally excited by an external vibration source (here the running gas turbine) if the latter acts with the same frequency as the natural frequency of the sensor bracket 1. The excitation frequency is dependent on the speed of the gas turbine not shown.

The natural vibration behavior of the sensor bracket 1 is dependent on three parameters—mass, component stiffness and damping of the sensor bracket 1. With mass and stiffness having countervailing effects, variability in setting the natural vibration behavior of the sensor bracket 1 is often severely compromised.

The structure of the sensor bracket 1 as per FIG. 2 is based on directly influencing the natural vibration behavior by using a fiber-composite material 10.

Fiber-composite materials have the property that the material stiffness is dependent on the volume share of the fibers 7 or 8, the type of the fibers 7 or 8, and the orientation of the fibers 7 or 8, respectively. Here, a variety of material and design parameters is available:
Type of the fibers 7 or 8, respectively (e.g. carbon fiber, glass fiber, aramid fiber)
Condition of the fibers 7 or 8, respectively (e.g. long fiber, short fiber)
Type of the matrix (duromer matrix (e.g. epoxy resin), thermoplast matrix (e.g. PEEK))
Fiber volume content (i.e. percentage of fibers in the component volume)
Form of supply of the fibers 7 or 8, respectively (e.g. prepreg, fabric, laying, unidirectional monolayers)
Type of manufacture (e.g. hand lay-up, autoclave, winding, braiding, tailored fiber placement)
Orientation of the fibers 7 or 8, respectively (i.e. angle of fiber orientation relative to the local axis x)

With the introduction of an adapted stiffness, individual natural frequencies of the sensor bracket 1 can be specifically changed, thereby preventing the sensors 5 from being influenced. This is accomplished by specifying the angle α of the fibers 7 relative to the local axis x and of the fibers 8 relative to the local axis z.

The natural frequency of a vibrating system follows the relation:

$$Natural frequency \approx \sqrt{\frac{stiffness}{mass}}$$

FIG. 3 shows the stiffness of the fiber-composite material 10 in dependence of the orientation of the fibers 7 (angle α) or the fibers 8 (angle β) as per FIG. 2, with the fibers 7 or 8, respectively, not being arranged vertically to each other, but exclusively in parallel with each other.

The dependence curve of the stiffness coefficient from the angle α or β, respectively, of the fiber orientation is cosinoidal, with all values being positive. Consequently, the maximum values of 50,000 MPa, for example, lie at an angle α or β, respectively, of 0° and 180°, while the minimum value of 10,000 MPa, for example, lies at an angle α or β, respectively, of 90° . The cosinoidal curve therefore allows the optimum angle α or β, respectively, to be read for any desired stiffness characteristic.

If the fibers 7 or 8, respectively, extend vertically to each other, as shown in FIG. 2, the curve is compressed to a range of α or β, respectively, of 0° to 90° . The maximum values then lie at an angle α or β, respectively, of 0° and 90°, while the minimum value lies at an angle α or β, respectively, of 45°.

FIG. 4 schematically shows the bending deformation for vibration at the natural frequency of the sensor bracket 1. Also here, the sensor bracket 1 includes the mounting part 1a, the center part 1b and the sensor part 1c. The sensor part 1c vibrates in the range of an angle γ about its rest position (solid line). The extreme positions of the sensor part 1c are shown by broken lines. The side members 6 are not explicitly shown.

By appropriately selecting the angle α for the fibers 7 (cf. FIG. 2), various vibration modes are influenceable as to the excitation frequencies at which they develop. This means that the natural frequencies too are definable in dependence of the excitation frequencies by selecting the angle α for the fibers 7.

FIG. 5a shows the sensor bracket 1 with an alternative material structure in a side view. The geometry of the sensor bracket 1 here corresponds to the geometry of the sensor bracket in FIG. 2.

With this alternative embodiment, the sensor bracket 1, including the mounting part 1a, the center part 1b concealed by the side member 6 and the sensor part 1c, is made of a metallic base 9 and an overlay in fiber-composite material 10 (hybrid design). The overlay in fiber-composite material 10 terminates flush with the edges of the metallic base 9, for example also at the end edge 3.

The overlay in fiber-composite material 10 is attached to the metallic base 9 by suitable joining methods, for example adhesive bonding.

In FIG. 5b, the sensor bracket 1 is shown in enlarged representation in the area of the sensor part 1c. The sensor part 1c, which is partly concealed by the side member 6, is formed by the metallic base 9 and the overlay in fiber-composite material 10. In the fiber-composite material 10, the fibers 7 extend in parallel with the metallic base 9. The metallic base 9 and the overlay in fiber-composite material 10 terminate at the end edge 3.

The side members 6 too can be made of a metallic base and an overlay in fiber-composite material 10.

In structural-mechanical terms, the overlay in fiber-composite material 10 is set such that, in combination with the metallic base 9, the vibration behavior of the sensor bracket 1 will not disturb the measurements of the sensors 5 (cf. FIG. 1).

In operation, both the sensor bracket 1 as per FIGS. 2 and 4 and the alternative embodiment of the sensor bracket 1 as per FIGS. 5a and 5b achieve the same effect.

In both cases, the fiber-composite material 10 is built up such that the orientation of the fibers 7 or 8, respectively, controls the stiffness, and thus the natural frequencies of the entire sensor bracket 1. The orientation of the fibers 7 or 8, respectively, is here selected such that the natural frequencies of the sensor bracket 1 lie outside of the frequency range, which includes the measuring range of the sensors 5. Accordingly, the measuring operation of the sensors 5 will not be disturbed, despite the excitation vibrations produced by the gas turbine not shown. This provides for reliable measurements throughout the operating range of the gas turbine.

### LIST OF REFERENCE NUMERALS

1 Sensor bracket

1a Mounting part

1b Center part

1c Sensor part

2 Mounting hole

3 End edge

4 Sensor hole

5 Sensor

6 Side member

7 Fiber

8 Fiber

9 Metallic base

10 Fiber-composite material

11 End edge

x Axis

α Angle

z Axis

β Angle

□ Angle

What is claimed is:

1. A sensor bracket for at least one sensor on a gas turbine, comprising at least one fiber-composite material having fibers embedded in the fiber-composite material that are oriented at an angle α relative to an axis x extending vertically to a free end edge of the sensor bracket in a plane established by the fibers, wherein a stiffness and natural frequencies of the sensor bracket are defined by the angle α such that the natural frequencies of the sensor bracket lie outside a frequency range of the sensor bracket, which includes a measuring range of the sensor.

2. The sensor bracket of claim 1, wherein the fibers are arranged parallel to each other in only one direction.

3. The sensor bracket of claim 1, wherein the fibers are arranged angularly to each other.

4. The sensor bracket of claim 2, wherein the stiffness and the natural frequencies of the sensor bracket are also defined by at least one of a type of the fibers, a texture of the fibers, a type of a fiber matrix, a fiber volume content, a form of delivery of the fibers and a type of manufacture of the fiber-composite material.

5. The sensor bracket of claim 4, wherein the sensor bracket is at least one of essentially z-shaped, essentially 1-shaped and essentially u-shaped, with the fibers following the shape of the sensor bracket.

6. The sensor bracket of claim 5, wherein the sensor bracket includes at least one side member which is also made of a fiber-composite material and whose fibers are arranged at an angle β relative to an axis z extending vertically to an end edge of the side member in a plane established by the fibers, with the stiffness and the natural frequencies of the sensor bracket being additionally defined by said angle β.

7. The sensor bracket of claim 6, wherein the sensor bracket includes a metallic base to which the fiber-composite material is applied.

8. The sensor bracket of claim 7, wherein the side member includes a metallic base to which the fiber-composite material is applied.

9. The sensor bracket of claim 3, wherein the stiffness and the natural frequencies of the sensor bracket are also defined by at least one of a type of the fibers, a texture of the fibers, a type of a fiber matrix, a fiber volume content, a form of delivery of the fibers and a type of manufacture of the fiber-composite material.

10. The sensor bracket of claim 9, wherein the sensor bracket is at least one of essentially z-shaped, essentially 1-shaped and essentially u-shaped, with the fibers following the shape of the sensor bracket.

11. The sensor bracket of claim 10, wherein the sensor bracket includes at least one side member which is also made of a fiber-composite material and whose fibers are arranged at an angle β relative to an axis z extending vertically to an end edge of the side member in a plane established by the fibers, with the stiffness and the natural frequencies of the sensor bracket being additionally defined by said angle β.

12. The sensor bracket of claim 11, wherein the sensor bracket includes a metallic base to which the fiber-composite material is applied.

13. The sensor bracket of claim 12, wherein the side member includes a metallic base to which the fiber-composite material is applied.

14. The sensor bracket of claim 1, wherein the stiffness and the natural frequencies of the sensor bracket are also defined by at least one of a type of the fibers, a texture of the fibers, a type of a fiber matrix, a fiber volume content, a form of delivery of the fibers and a type of manufacture of the fiber-composite material.

15. The sensor bracket of claim 1, wherein the sensor bracket is at least one of essentially z-shaped, essentially 1-shaped and essentially u-shaped, with the fibers following the shape of the sensor bracket.

16. The sensor bracket of claim 1, wherein the sensor bracket includes at least one side member which is also made of a fiber-composite material and whose fibers are arranged at an angle β relative to an axis z extending vertically to an end edge of the side member in a plane established by the fibers, with the stiffness and the natural frequencies of the sensor bracket being additionally defined by said angle β.

17. The sensor bracket of claim 16, wherein the side member includes a metallic base to which the fiber-composite material is applied.

18. The sensor bracket of claim 1, wherein the sensor bracket includes a metallic base to which the fiber-composite material is applied.
